(19) United States
(12) Patent Application Publication
(10) Pub. No.: US 2006/0204020 A1
(43) Pub. Date: Sep. 14, 2006

(54) System for the digital processing of an acoustic or electrical signal, and telephone set provided with such a processing system

(76) Inventors: Grégoire Le Tourneur, St Quay-Perros (FR); Patrick Chany, St Denis (FR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(21) Appl. No.: 10/557,839

(22) PCT Filed: Apr. 27, 2004
(86) PCT No.: PCT/FR04/01016

§ 371 Date: Nov. 21, 2005

(30) Foreign Application Priority Data
Jun. 24, 2003 (FR) 03/07,635

(51) Int. Cl. H04B 15/00

(52) U.S. Cl. 381/94.1

(57) ABSTRACT

The system for digitally processing an acoustic signal is arranged in a telephone set provided with a loudspeaker and a microphone, between the loudspeaker and the microphone. The system has an automatic gain control circuit associated with an echo cancellation device. It also comprises calculation means which are configured to apply a transfer function of the automatic gain control means to the echo cancellation device input, so that the signal from the microphone and the signal for the loudspeaker are each manipulated by a function comprising the same term, corresponding to the transfer function of the automatic gain control means.

The invention pertains to the digital processing of signals and relates, in particular, to acoustic or electrical echo cancellation in telecommunication sets. An interesting application of such a system relates to electrical echo cancellation in a telecommunication terminal or in any type of telecommunication equipment confronted with this electrical echo problem.

Another particularly interesting application of such a system relates to echo cancellation in a telecommunication set offering hands-free operation.

Specifically, acoustic echo is a major obstacle to the proper operation of the communication software of a subscriber's terminal equipment. This obstacle is encountered acutely in sets equipped with a so-called “hands free” function. For example, in the case of a telephone set, the acoustic echo occurs when the signal emitted by the loudspeaker, which corresponds to a signal uttered by a remote talker, is picked up by the microphone. This then translates, in respect of this remote user, into the restitution, at the earpiece level, of the signal with a shift with respect to the instant of emission. The reduction, or even cancellation of the echo, is obtained by equipping the sets with echo canceller devices.

The hands-free mode of operation additionally raises a problem of dynamic range in respect of the signals processed, the level of the microphone then varying within a very wide span. This large variation in level is due essentially to the talker's receding from or approaching the microphone, as well as to the natural variety of power of speech between individuals.

The sound capture system has, for its part, a finite dynamic range, related to the presence of an analog/digital converter within the digital processing system with which the set is equipped. It is therefore necessary to tailor the dynamic range of the acoustic signal acquisition chain to the application envisaged. Thus, either the soft levels are favored thereby engendering a risk of saturation at input in respect of the loud levels, that is to say for loud voices or when the talker is close to the microphone, or the loud levels are favored in such a way as to avoid any saturation, thereby engendering the occurrence of noise in respect of the soft levels and hence a degradation in the signal for such levels due to quantization noise related to the presence of the converter.

To alleviate this drawback, the systems for the digital processing of acoustic signals conventionally use a automatic gain control device or AGC to tailor the large dynamic range of the signal at the microphone level to the limited dynamic range of the sound capture system. This device is intended to keep the level of the output signal constant over a predetermined usage span so as to thus allow the conversion of the signal after intervention of the automatic gain control device with good accuracy for the small levels and also for the loud levels whose amplitude has been reduced.

Such devices operate relatively effectively. They nevertheless raise major problems when they are used jointly with an acoustic echo canceller. Specifically, an echo canceller is based on the estimation of an impulse response between a loudspeaker and a microphone, on condition that the said response is linear. However, an automatic gain control device does not satisfy this criterion since it modifies the gain levels applied according to the energy of the input signal.

It is nevertheless possible to couple an automatic gain control device to an echo canceller device when the transfer function of the automatic gain control device is well known. To do this, the inverse transfer function of the automatic gain control device is applied to the signal after analog/digital conversion.

Nevertheless, even when the response of the automatic gain control device is known perfectly, the coupling may be impossible when using a calculation system which uses a fixed-point architecture for applying compensation to the signal after analog/digital conversion. Specifically, for example, when using a fixed-point calculation system having a capacity of 16 bits, the output values of the calculation system necessarily lie between −32768 and +32767. If a 16-bit converter is also used, it is no longer possible to apply the inverse transfer function of the automatic gain control device without saturating the signal and thereby rendering the overall system nonlinear.

The problem is similar for telecommunication systems integrating a function of cancellation of electrical echo and of AGC function on the signal or signals received from the line or lines, so as to compensate for the disparities of fading of the lines.

Specifically, the electrical echo cancellers are also based on estimation of an impulse response between the signal emitted into the line and the signal received from the line.

In view of the foregoing, the aim of the invention is to alleviate the drawbacks of the prior art and to provide a system for the digital processing of an acoustic or electrical signal in which it is possible to operate an automatic gain control device and an echo canceller jointly, even using a fixed-point calculation system.

According to the invention, there is therefore proposed a system for the digital processing of an acoustic signal, which is intended to be disposed in a set equipped with a loudspeaker and with a microphone between said loudspeaker and said microphone and which comprises automatic gain control means associated with an echo canceller device.

This digital processing system comprises calculation means suitable for applying a transfer function of the automatic gain control means to the input of the echo canceller device in such a way that a signal originating from the microphone and a reference signal are each manipulated by a function comprising one and the same term corresponding to the transfer function of the automatic gain control means.

It consequently becomes possible to factorize the transfer function of the automatic gain control means in such a way that, during the processing of the signal implemented by the system, this function no longer intervenes and is no longer taken into account by the algorithm of the echo canceller.

According to the invention, there is also proposed a system for the digital processing of an acoustic signal, said system being intended to be disposed in a set equipped with a loudspeaker and with a microphone between said loudspeaker and said microphone and comprising automatic gain control means associated with an echo canceller device, characterized in that it comprises calculation means suitable for applying a transfer function of the automatic gain control means to the input of the echo canceller device in such a way that the signal originating from the microphone and the input signal of the echo canceller device are each manipulated by a function comprising one and the same term corresponding to the transfer function of the automatic gain control means.

According to another characteristic of the invention, one or the other system furthermore comprises multiplier means suitable for carrying out an operation of multiplication between the reference signal and the transfer function of the automatic gain control means.

In an embodiment, the acoustic or electrical echo canceller device comprises a digital filter whose coefficients are calculated in such a way as to minimize the error between the echo and an estimate of the echo.

According to another characteristic of the invention, the echo and the estimate of the echo are defined respectively by the following equations:
Echo(t)=(Ref(t)×H(t))AGC(t)
and
Estimate(t)=(Ref(t)×AGC(t))Hₑₛₜ(t)

in which:

Ref designates the reference signal intended for the echo canceller device;

H(t) designates the transfer function of the echo between the loudspeaker and the microphone; and

Hₑₛₜ(t) designates the transfer function of the estimate of the echo or the transfer function of the echo between the signal emanating from the microphone and the signal returned by the line.

By way of example, as far as the automatic gain control means are concerned, the latter generally comprise a stage with transfer function represented by a curve of parabolic type.

According to the invention, there is also proposed a telephone set equipped with one of the digital processing systems as defined hereinabove.

Other aims, characteristics and advantages of the invention will become apparent on reading the following description, given merely by way of nonlimiting example, and offered with reference to the appended drawings in which:

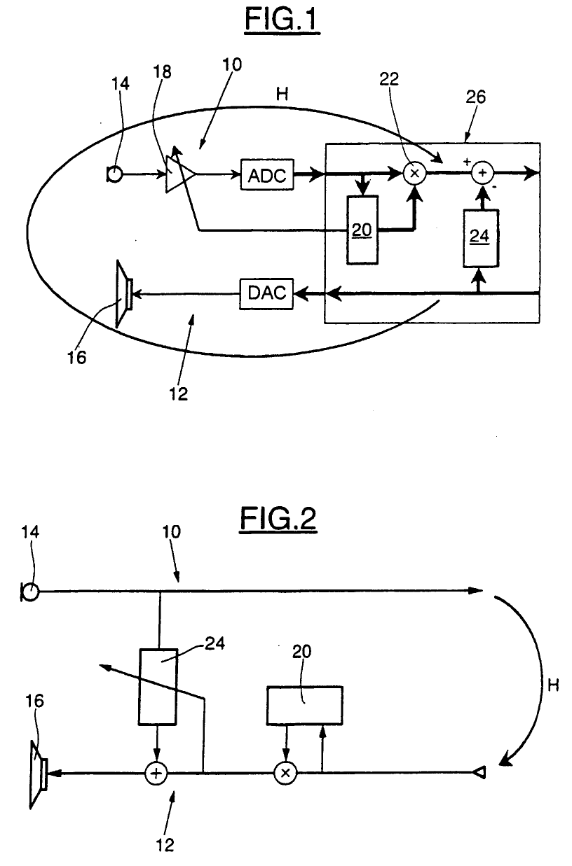

FIG. 1 illustrates the embodiment of a digital processing system for an acoustic signal according to the prior art, equipped with an echo canceller and with automatic gain control means;

FIG. 2 illustrates the embodiment of a system for processing the electrical echo according to the prior art, equipped with an electrical echo canceller and with automatic gain control means;

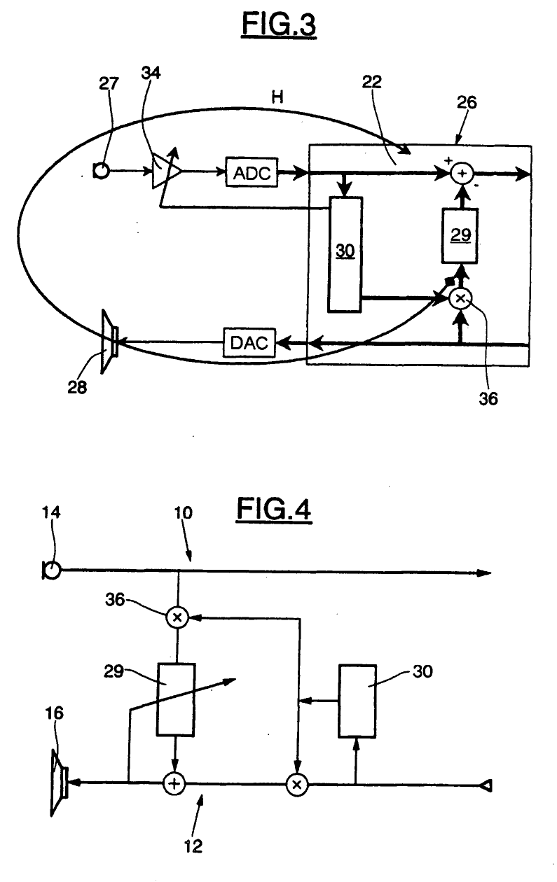

FIG. 3 illustrates the structure of a digital processing system for the acoustic echo in accordance with the invention;

FIG. 4 illustrates the structure of a digital processing system for the electrical echo in accordance with the invention;

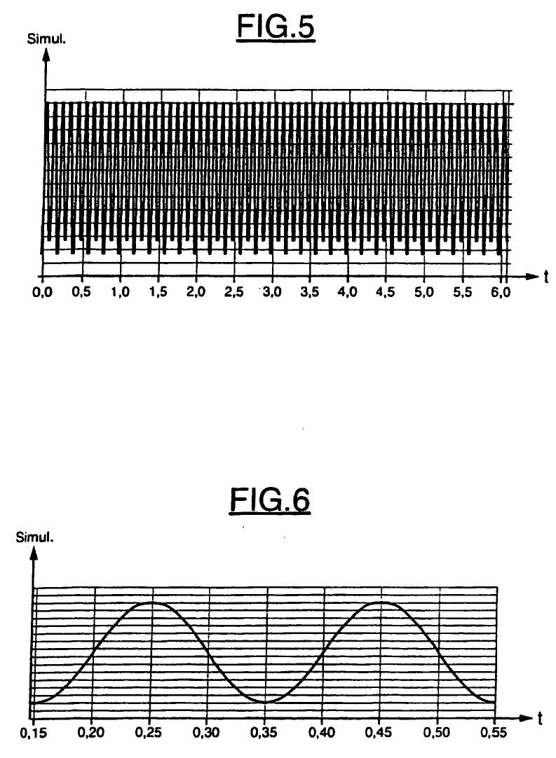

FIGS. 5 to 10 are curves illustrating the manner of operation of the digital processing system in accordance with the invention.

Represented in FIG. 1 is an exemplary digital processing system for an acoustic signal according to the state of the art, provided with an automatic gain control device and with an echo canceller, and for which the transfer function of the automatic gain control device is well known.

As may be seen in this figure, this system comprises a sound acquisition chain 10 and a sound restitution chain 12 respectively comprising a microphone 14 associated with an analog/digital converter ADC and a loudspeaker 16 associated with a digital/analog converter DAC. The sound acquisition chain 10 is moreover provided with an variable-gain amplifier 18. As far as the system for the digital processing of the signals 18 is concerned, it comprises an automatic gain control module 20 driving the variable-gain amplifier 18 in such a way as to tailor the dynamic range of the input signal to that of the analog/digital converter while keeping the level of the output signal constant over the usage span of the system.

Moreover, the AGC module 20 is associated with a multiplier 22 disposed in the acquisition chain 10 in such a way as to apply the inverse transfer function AGC⁻¹ of the automatic gain control module to the signal emanating from the analog/digital converter. Thus, the overall transfer function of the echo H seen by the echo canceller 24 is independent of the transfer function of the automatic gain control device AGC so that the system becomes linear for the estimation of the impulse response. As indicated previously, this type of compensation requires accurate knowledge of the behavior of the automatic gain control device. Furthermore, it requires the use of a calculation system having a floating-point architecture.

Represented in FIG. 2 is an electrical echo processing system according to the state of the art. In this figure, elements identical to those of FIG. 1 are designated by the same numerical references.

As previously, the system visible in this FIG. 2 also comprises a sound acquisition chain 10 and a sound restitution chain 12 respectively comprising a microphone 14 and a loudspeaker 16. As in the system described with reference to FIG. 1, this system comprises an automatic gain control module 20 and an electrical echo canceller 24 which are intended to compensate for the disparities of fading of the lines.

As in the example described with reference to FIG. 1, the electrical echo canceller is also based on estimation of an impulse response between the signal emitted on the line and the signal received therefrom.

Represented in FIG. 3 is the general structure of a system for the digital processing of acoustic signals in accordance with the invention making it possible to alleviate the aforesaid drawbacks.

In the exemplary embodiment represented, this system, designated by the general numerical reference 26, is intended to be disposed within a telephone set, such as for example a mobile telephone set having a so-called “hands free” function, between a microphone 27 and a loudspeaker 28. It is essentially intended to cater for the processing of the voice signals picked up by the microphone 27 so as to cancel the echo liable to occur when the microphone 27 picks up the voice signals originating from a remote talker and restored by the loudspeaker 28.

For this purpose, the system 26 is provided with an echo canceller device 29 consisting of a digital filter catering essentially for calculation of the estimate of the echo on the basis of a reference signal Ref corresponding, in the application envisaged, to a signal received, that is to say to a signal originating from the microphone of a remote telephone set. Furthermore, the system 26 is provided with automatic gain control means 30 catering, in a conventional manner, for a processing of the signals picked up by the microphone 27 in such a way as to tailor their dynamic range to that of the analog/digital converter ADC with which the acquisition chain of which the microphone 27 forms part is equipped. To this end, the automatic gain control means generally comprise a transfer function whose output curve as a function of input has for example the shape of a parabola so as to keep the output level of the acquisition chain almost constant over the operating span of the microphone 27. To do this, the automatic gain control means drive a variable-gain amplifier 34 so as to obtain such behavior.

A similar arrangement is used for the cancellation of the electrical echo. As may be seen in FIG. 4, for the digital processing of an electrical signal so as to cancel the electrical echo related to the problem of fading on the telecommunication line, the digital processing system also comprises an echo canceller device 29 consisting of a digital filter able to calculate the estimates of the electrical echo on the basis of a reference signal Ref corresponding to a signal conveyed on the telecommunication line and automatic gain control means 30.

As previously, the transfer function AGC of the automatic gain control means 30 is applied as input to the echo canceller device 29 by means of a multiplier 36.

Specifically, in both embodiments visible in FIGS. 3 and 4, with the aim of avoiding any problem related to the joint use of the echo canceller device 29 and of the automatic gain control means 30, the transfer function AGC of the automatic gain control means 30 is applied as input to the echo canceller device 29 by means of the multiplier 36 to which the reference signal Ref is also applied. Thus, by designating by H(t) the echo's overall transfer function as it is seen by the processing system 26 and by the estimate Hₑₛₜ(t) of this transfer function, the echo Echo (t) and the estimate of the echo Estimate (t) are defined respectively by the following equations:
Echo(t)=(Ref(t)×H(t))AGC(t)
and
Estimate(t)=(Ref(t)×AGC(t))Hₑₛₜ(t)

These equations are identical for an acoustic echo cancellation system and for an electrical echo cancellation system.

The echo canceller device 29 comprises a digital filter whose coefficients are calculated in such a way as to minimize the error between the echo and the estimate of the echo. The coefficients are calculated in a recurrent manner on the basis of previously calculated coefficients, of the error between the estimate of the echo and the echo, of the reference signal and of an adaptation stepwise μ, on the basis of the following equation:
Coefficient=(n+1)=Coefficient(n)μ×error×Ref

The minimization of the mean square error between the echo and the estimate of the echo amounts to minimizing the following quantity:
Error(t)=Echo(t)−Estimate (t)
i.e.:
Error(t)=[Ref(t)×H(t)]×AGC(t)−[Ref(t)×AGC(t)]×Hₑₛₜ(t)

Under the assumption of stationarity of the transmission channel, the convolution product is associative. The above formula then becomes:
Error(t)=Ref(t)×[H(t)−Hₑₛₜ(t)]×AGC(t)

As may be appreciated, the application of the transfer function AGC as input to the echo canceller device 29 makes it possible to obtain, in each of the equations defining the echo and the estimate of the echo, a term AGC (t) that can be factorized in the equation defining the error between the echo and the estimate of the echo.

The solution for the cancellation of the error on the basis of the above equation consists in making the echo and the estimate of the echo equal. This solution is therefore identical to that of a digital processing system in which no AGC function is introduced into the signal emanating from the microphone. A solution identical to a solution in which no automatic gain control is provided is thus recovered.

By virtue of the invention, it is possible to preserve the signal emanating from the microphone at the output of the analog/digital converter with a level close to the maximum, while remaining nonsaturated, and to apply the automatic gain control to the reference signal of the echo canceller rather than to the signal emanating from the converter.

An exemplary result obtained by means of a system for digital processing of signals in accordance with the invention will now be described with reference to FIGS. 3 to 8.

Represented in FIGS. 5 and 6 is the profile as a function of time t of a sinusoidal signal Simul for simulating the automatic gain control device intended to simulate the variable gain to be applied to a signal received by the microphone. This signal Simul exhibits an amplitude varying between 0.1 and 0.7 in 100 ms. FIG. 6 constitutes a magnified view of the curve represented in FIG. 5.

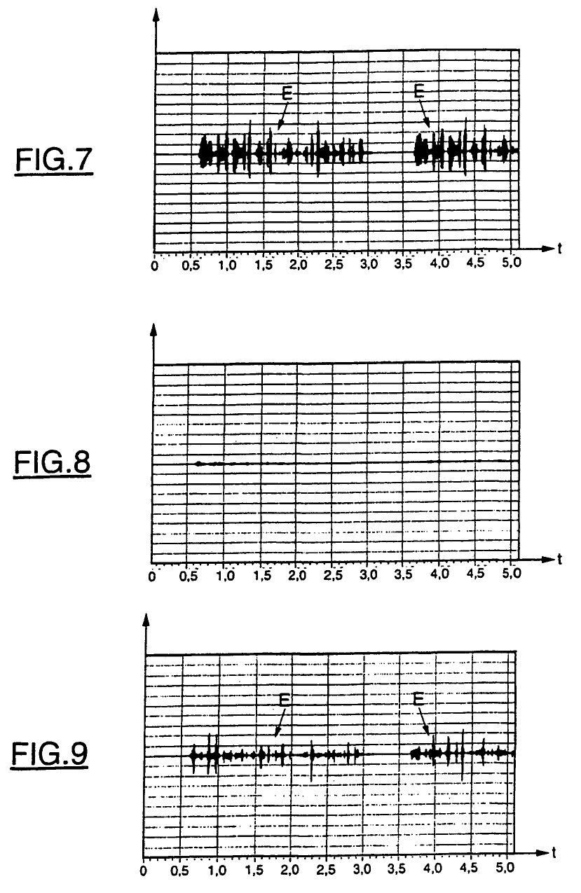

The voice signal picked up by the microphone is represented in FIG. 7. As may be seen in this figure, this signal consists solely of echos E.

Represented in FIG. 8 is the profile of the signal at the output of a digital processing system comprising only an echo canceller device and therefore devoid of automatic gain control applied to the signal emanating from the microphone. As may be seen in this figure, after echo cancellation, on account of the absence of nonlinear function in the processing system, the signal processed is devoid of echo. However, on account of the reasons setforth above, no processing intended to tailor the dynamic range of the signal received to the range of the acquisition chain can be applied.

Represented in FIG. 9 is the profile of the signal processed by means of another signal processing system in which automatic gain control is applied only to the signal emanating from the microphone, without other compensation either according to FIG. 1 or according to FIG. 2. As may be seen in this FIG. 9, the echos E are still present, although attenuated.

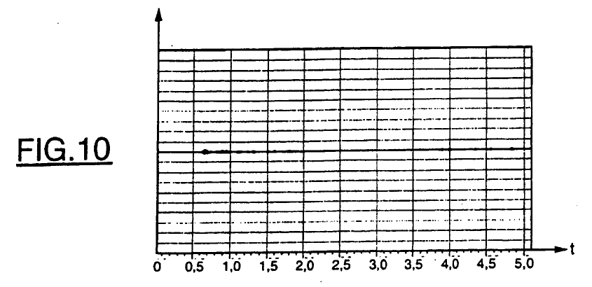

Represented in FIG. 10 is the result of a processing in accordance with the invention, according to which the transfer function of the automatic gain control means is applied, on the one hand, to the signal emanating from the mike and, on the other hand, to the reference signal. It is then observed that the echos have actually been eliminated.

1. A system for digital processing of an acoustic signal, the system being disposed between a loudspeaker and a microphone, the system comprising:
automatic gain control means;
an echo canceller device;
calculation means for applying a transfer function of the automatic gain control means to an input of the echo canceller device so that a signal originating from the microphone and an input signal of the echo canceller device are each manipulated by a function comprising a common term corresponding to the transfer function of the automatic gain control means.

2. The system as claimed in claim 1, further comprising multiplier means for carrying out an operation of multiplication between a reference signal corresponding to the input signal of the echo canceller device and the transfer function of the automatic gain control means.

3. The system as claimed in claim 1, wherein the echo canceller device comprises a digital filter having coefficients calculated in such a way as to minimize an error between an echo and an estimate of the echo.

4. The system as claimed in claim 3, wherein the echo and the estimate of the echo are defined respectively by the following relations:
Echo(t)=(Ref(t)×H(t))AGC(t)
and
Estimate(t)=(Ref(t)×AGC(t))Hₑₛₜ(t)
in which:
Ref designates the input signal of the echo canceller device;
H(t) designates the transfer function of the echo between the loudspeaker and the microphone;
AGC(t) designates the transfer function of the automatic gain control means; and
Hₑₛₜ(t) designates the transfer function of the estimate of the echo.

5. The system as claimed in claim 1, wherein the automatic gain control means comprise a stage having a transfer function represented by a parabolic curve.

6. A system for digital processing of an acoustic signal, the system being disposed between a loudspeaker and a microphone, the system comprising:
automatic gain control means;
an echo canceller device;
calculation means for applying a transfer function of the automatic gain control means to an input of the echo canceller device so that a signal originating from a telecommunication line to which the set is attached and an input signal of the echo canceller device are each manipulated by a function comprising a common term corresponding to the transfer function of the automatic gain control means.

7. The system as claimed in claim 6, further comprising multiplier means for carrying out an operation of multiplication between a reference signal corresponding to the input signal of the echo canceller device and the transfer function of the automatic gain control means.

8. The system as claimed in claim 6, wherein the echo canceller device comprises a digital filter having coefficients calculated in such a way as to minimize an error between an echo and an estimate of the echo.

9. The system as claimed in claim 8, wherein the echo and the estimate of the echo are defined respectively by the following relations:
Echo(t)=(Ref(t)×H(t))AGC(t)
and
Estimate(t)=(Ref(t)×AGC(t))Hₑₛₜ(t)
in which:
Ref designates the input signal of the echo canceller device;
H(t) designates the transfer function of the echo between the signal received by the microphone and the signal received by the telecommunication line;
AGC(t) designates the transfer function of the automatic gain control means; and
Hₑₛₜ(t) designates the transfer function of the estimate of the echo.

10. The system as claimed in claim 6, wherein the automatic gain control means comprise a stage having a transfer function represented by a parabolic curve.

11. A telephone set, comprising a loudspeaker, a microphone, and a digital processing system disposed between said loudspeaker and said microphone, wherein the digital processing system comprises:
automatic gain control means;
an echo canceller device;
calculation means for applying a transfer function of the automatic gain control means to an input of the echo canceller device so that a signal originating from the microphone and an input signal of the echo canceller device are each manipulated by a function comprising a common term corresponding to the transfer function of the automatic gain control means.

12. The telephone set as claimed in claim 11, wherein the digital processing system further comprises multiplier means for carrying out an operation of multiplication between a reference signal corresponding to the input signal of the echo canceller device and the transfer function of the automatic gain control means.

13. The telephone set as claimed in claim 11, wherein the echo canceller device comprises a digital filter having coefficients calculated in such a way as to minimize an error between an echo and an estimate of the echo.

14. The telephone set as claimed in claim 13, wherein the echo and the estimate of the echo are defined respectively by the following relations:
Echo(t)=(Ref(t)×H(t))AGC(t)
and
Estimate(t)=(Ref(t)×AGC(t))Hₑₛₜ(t)
where:
Ref designates the input signal of the echo canceller device;
H(t) designates the transfer function of the echo between the loudspeaker and the microphone;
AGC(t) designates the transfer function of the automatic gain control means; and
Hₑₛₜ(t) designates the transfer function of the estimate of the echo.

15. The telephone set as claimed in claim 11, wherein the automatic gain control means comprise a stage having a transfer function represented by a parabolic curve.

16. A telephone set, comprising a loudspeaker, a microphone, an interface with a telecommunication line, and a digital processing system disposed between said loudspeaker and said microphone, wherein the digital processing system comprises:
automatic gain control means;
an echo canceller device;
calculation means for applying a transfer function of the automatic gain control means to an input of the echo canceller device so that a signal originating from the telecommunication line and an input signal of the echo canceller device are each manipulated by a function comprising a common term corresponding to the transfer function of the automatic gain control means.

17. The telephone set as claimed in claim 16, wherein the digital processing system further comprises multiplier means for carrying out an operation of multiplication between a reference signal corresponding to the input signal of the echo canceller device and the transfer function of the automatic gain control means.

18. The telephone set as claimed in claim 16, wherein the echo canceller device comprises a digital filter having coefficients calculated in such a way as to minimize an error between an echo and an estimate of the echo.

19. The telephone set as claimed in claim 18, wherein the echo and the estimate of the echo are defined respectively by the following relations:
Echo(t)=(Ref(t)×H(t))AGC(t)
and
Estimate(t)=(Ref(t)×AGC(t))Hₑₛₜ(t)
where:
Ref designates the input signal of the echo canceller device;
H(t) designates the transfer function of the echo between the signal received by the microphone and the signal received by the telecommunication line;
AGC(t) designates the transfer function of the automatic gain control means; and
Hₑₛₜ(t) designates the transfer function of the estimate of the echo.

20. The telephone set as claimed in claim 16, wherein the automatic gain control means comprise a stage having a transfer function represented by a parabolic curve.
